(19) United States
(12) Patent Application Publication
(10) Pub. No.: US 2016/0172957 A1
(43) Pub. Date: Jun. 16, 2016

(54) A MAGNETIC GEAR

(71) Applicant: RICARDO UK LIMITED, Sussex (GB)

(72) Inventors: Andrew Farquhar Atkins, Sussex (GB); Joshua Dalby, Sussex (GB); Hing Wung To, Sussex (GB); Simon Shepherd, Sussex (GB)

(73) Assignee: Ricardo UK Limited, Sussex (GB)

(21) Appl. No.: 14/907,783

(22) PCT Filed: Jul. 25, 2014
(86) PCT No.: PCT/GB2014/052294

§ 371 Date: Jan. 26, 2016

(30) Foreign Application Priority Data
Jul. 26, 2013 (GB) 1313424.2

(51) Int. Cl. H02K 49/10; H02K 51/00; H02K 9/00

(52) U.S. Cl. CPC H02K 49/102; H02K 9/005; H02K 51/00; H02K 2209/00

(57) ABSTRACT

A magnetic gear comprising: first and second members arranged for relative movement therebetween, the first member having a first array of magnetic field generating elements and the second member having a second array of magnetic field generating elements; and a coupling member having an array of coupling elements for coupling magnetic flux between the first array of magnetic field generating elements and the second array of magnetic field generating elements, wherein for at least one of the coupling elements, there is provided a cooling path in thermal communication with the at least one coupling element, wherein the cooling path is provided within at least one of the at least one coupling element and the coupling member.

This invention relates to a magnetic gear.

Magnetic gears allow contactless transmission of kinetic energy from a first member having a first array of magnetic field generating elements to a second member having a second array of magnetic field generating elements. This contactless transmission can reduce energy losses and also enables isolation of drive and driven components. This isolation allows the environment within which the driven component is placed to be sealed from the drive component, allowing, for example, the driven component to be placed within a chamber whose environment can be separately controlled, for example placed under vacuum or low pressure. Isolation of the driven member may also be advantageous in pumps because it can allow, for example, noxious or corrosive substances being pumped to be isolated from the drive component.

Magnetic gears may comprise a coupling member having an array of coupling elements for coupling magnetic flux between the first array of magnetic field generating elements and the second array of magnetic field generating elements.

In operation, magnetic flux will pass from the magnetic elements on the first and second member through coupling member. Relative movement, for example relative rotation, of the first and second members leads to a change in magnetic flux in the coupling member which, in turn, induces eddy currents in the coupling elements. The induced eddy currents will lead to inductive heating of the coupling elements and further heating will be created by the hysteresis affects due to the change in flux.

In an attempt to reduce heating and help to prevent overheating of the coupling elements the coupling elements can be designed to have a large surface area to volume ratio to enable heat flow from the coupling element to reduce heating of the coupling element during use. However, increasing the surface area to volume ratio may not be sufficient to maintain the temperature of the coupling element within acceptable limits.

### STATEMENTS OF INVENTION

An embodiment of the disclosure provides a magnetic gear comprising: first and second members arranged for relative movement therebetween, the first member having a first array of magnetic field generating elements and the second member having a second array of magnetic field generating elements; and coupling member having an array of coupling elements for coupling magnetic flux between the first array of magnetic field generating elements and the second array of magnetic field generating elements, wherein for at least one of the coupling elements, there is provided a cooling path in thermal communication with the at least one coupling element, wherein the cooling path is provided within at least one of the at least one coupling element and the coupling member.

The cooling path in thermal communication with the coupling element enables cooling of the coupling element and may avoid or reduce the possibility of the coupling element overheating due to inductive heating of the coupling element.

The cooling path may be provided at least partially through the at least one coupling element.

The cooling path may comprise a channel extending at least partially through the at least one coupling element.

The cooling path may be provided adjacent to the coupling element.

The at least one cooling path may comprises a channel extending adjacent to a surface of the coupling element.

A cross section of the at least one coupling element may have at least one bevelled corner.

The least one bevelled corner may provide at least part of the at least one cooling path between the at least one coupling element and surfaces of the coupling member supporting the at least one coupling element. Bevelling the corners enable provision of cooling channels and also should reduce the concentration of magnetic flux, which would otherwise occur at the corners of the coupling element, and so should assist in reducing inductive heating.

The cooling path may extend only partially through the coupling element and/or the coupling member

The cooling path may be a fluid path and the magnetic gear may further comprise a condensing plate at a closed end of the fluid path.

The coupling element may have a single cooling path.

The at least one coupling element may have a single cooling path, wherein the single cooling path is provided within the coupling element.

The cooling path may be provided centrally within a cross section of the coupling element.

The at least one coupling element may be provided with two cooling paths.

The at least one coupling element may be provided with two cooling paths, wherein the two cooling paths are provided within the coupling element.

The two cooling paths may be arranged symmetrically about an axis of a cross section of the coupling element.

The cooling path may be a fluid path and one of the two fluid paths may be arranged to provide a fluid return path.

The at least one coupling element may be provided with a plurality of cooling paths.

The at least one coupling element may have a first cooling path and a plurality of further cooling paths arranged around the first cooling path.

The first cooling path may be arranged centrally within the at least one coupling element.

The further cooling paths may be arranged symmetrically about the central cooling path.

The further cooling paths may be provided by bevelled corners of the at least one coupling element.

The cooling path may be a fluid path and at least one of the plurality of fluid paths may provide a fluid return path.

At least one cooling path may be provided for each of the coupling elements.

The cooling path may be a fluid path and a flow control element may be configured to control the flow of a fluid along the at least one fluid path.

The cooling path may be a fluid path and the flow control element may be configured to control the flow of fluid along the at least one fluid path based on a temperature of the at least one coupling element.

The cooling path may be a fluid path and a controller may be configured to control the flow of fluid along the at least one fluid path.

The cooling path may be a fluid path and the controller may be configured to receive an indication of a measured temperature of the at least one coupling element and to control the flow of fluid along the at least one fluid path based on the measured temperature.

The cooling path may be a fluid path and the controller may be configured to store an indication of a reference temperature and to control the flow of fluid along the at least one fluid path based on a comparison between the measured temperature and the reference temperature. The heating of the coupling element due to inductive heating may vary at different stages of operation of the magnetic gear. The controller may enable the cooling of the coupling element to be varied according to the requirements of a particular stage of operation, thus potentially enhancing the efficiency of the cooling mechanism.

The cooling path may be a fluid path and the controller may be configured to control a fluid pump to control the flow of fluid along the at least one fluid path.

The cooling path may be a fluid path and the fluid pump may comprise an electric pump, a mechanical pump or a hydraulically driven pump

The cooling path may be a fluid path and the controller may be configured to control the pressure of the fluid to control the flow of fluid along the at least one fluid path.

The cooling path may be a fluid path and the at least one fluid path may be coupled to a tap, wherein controller is configured to control the tap to control the pressure of the fluid.

The first and second members may be arranged concentrically for relative rotation therebetween, wherein the coupling member is provided intermediate the first and second members for coupling magnetic flux between the first and second arrays in a radial direction.

The first and second members may be axially spaced apart, wherein the coupling member is provided intermediate the first and second members for coupling magnetic flux between the first and second arrays in an axial direction.

The first member, the second member and the coupling member may be arranged coaxially.

The one of the first and second members may be coupled to an input shaft of the magnetic gear and the other of the first and second members is coupled to an output shaft of the magnetic gear.

The output shaft may be coupled to a flywheel.

The output shaft may be arranged in a vacuum chamber.

The coupling member may form part of a barrier enclosing the vacuum chamber.

The cooling path may be a fluid path and the magnetic gear may comprise a mechanical gear mounted on the output shaft, wherein the mechanical gear is configured to cause a fluid to be pumped along the at least one fluid path in proportion to the rotational speed of the output shaft.

The cooling path may be a fluid path and the coupling member may comprise a fluid supply path to supply fluid from a fluid reservoir to the at least one fluid path.

The cooling path may be a fluid path and the coupling member may comprise a fluid return path to receive fluid which has passed along the at least one fluid path.

The cooling path may be a fluid path and the fluid return path may be arranged to return fluid which has passed along the at least one fluid path to the reservoir.

The at least one cooling path may comprise a fluid path and the heat exchanger comprises a condensing plate.

The at least one cooling path may comprise a material of lower magnetic permeability in place of or in addition the at least one fluid path.

The material of lower magnetic permeability may comprise a solid, liquid or gas.

The material of lower permeability may have a cooling path and/or a porous or open cell structure.

The material of lower magnetic permeability may comprise a material selected from the group consisting of a material comprising aluminium, a material comprising copper and a composite material.

In an embodiment a magnetic gear comprises: first and second members arranged for relative movement therebetween, the first member having a first array of magnetic field generating elements and the second member having a second array of magnetic field generating elements; and coupling member having an array of coupling elements for coupling magnetic flux between the first array of magnetic field generating elements and the second array of magnetic field generating elements, wherein for at least one of the coupling elements, there is provided a fluid path in thermal communication with the at least one coupling element, wherein the fluid path is provided within at least one of the at least one coupling element and the coupling member.

In an embodiment a magnetic gear may comprise: first and second members arranged for relative movement therebetween, the first member having a first array of magnetic field generating elements and the second member having a second array of magnetic field generating elements; and a coupling member having an array of coupling elements for coupling magnetic flux between the first array of magnetic field generating elements and the second array of magnetic field generating elements, wherein for at least one of the coupling elements, there is provided a channel extending at least partially through the at least one coupling element, the channel comprises a material of a lower magnetic permeability than the coupling element.

An embodiment of the disclosure provides a magnetic gear comprising first and second members arranged for relative movement therebetween. The first member having a first array of magnetic field generating elements and the second member having a second array of magnetic field generating elements and a coupling member having an array of coupling elements for coupling magnetic flux between the first array of magnetic field generating elements and the second array of magnetic field generating elements, wherein at least one of the coupling elements has a substantially rectangular cross section with at least one bevelled corner.

The bevelled corner may provide a cooling path between the at least one coupling element and surfaces of the coupling member supporting the coupling element.

Each of the corners of the at least one coupling element may be bevelled.

The coupling member may have an outer circumferential surface.

The outer circumferential surface may be configured to carry the coupling elements.

The outer circumferential may comprise a plurality of recesses for supporting the plurality of coupling elements therein.

The recesses may be configured such that outer surfaces of the respective coupling elements carried therein are flush with the outer circumferential surface.

The coupling elements may be provided beneath the outer circumferential surface.

The coupling member may have an inner circumferential surface.

The inner surfaces of the respective coupling elements may be flush with the inner circumferential surface.

The coupling elements may be provided beneath the inner circumferential surface.

A vehicle may comprise the magnetic gear described above.

An embodiment of the disclosure provides a method of operating the magnetic gear, wherein the cooling path is a fluid path, the method comprising effecting relative movement between the first and second members and supplying fluid to the at least one fluid path to cool the at least one coupling element.

### DETAILED DESCRIPTION

Aspects of the disclosure are also described in detail, by way of example only, with reference to the accompanying drawings, in which:

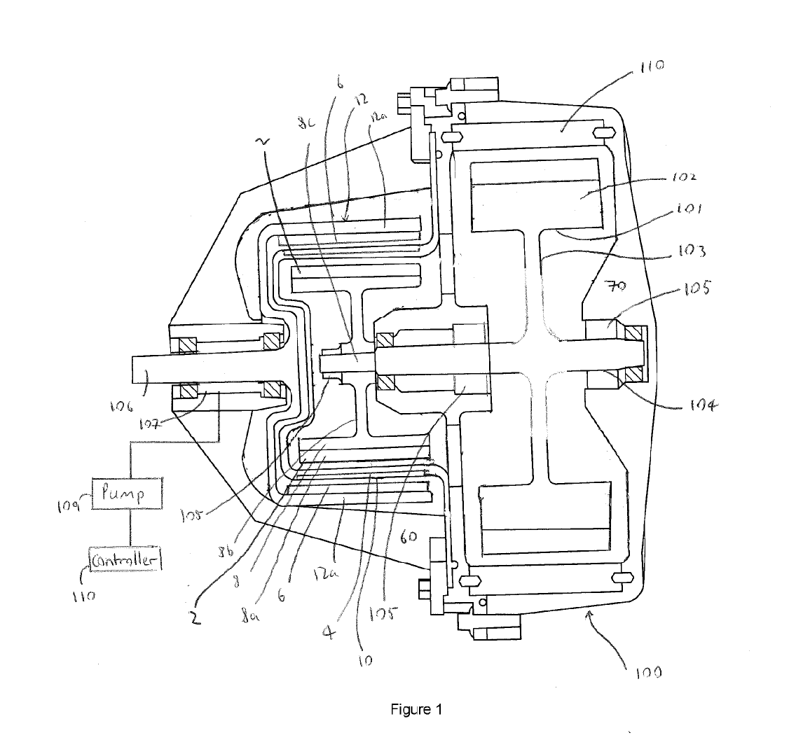

FIG. 1 shows a diagrammatic cross sectional view of a flywheel assembly having a magnetic gear with a coupling member having a plurality of coupling elements and providing a barrier between the first and second array of magnetic field generating elements;

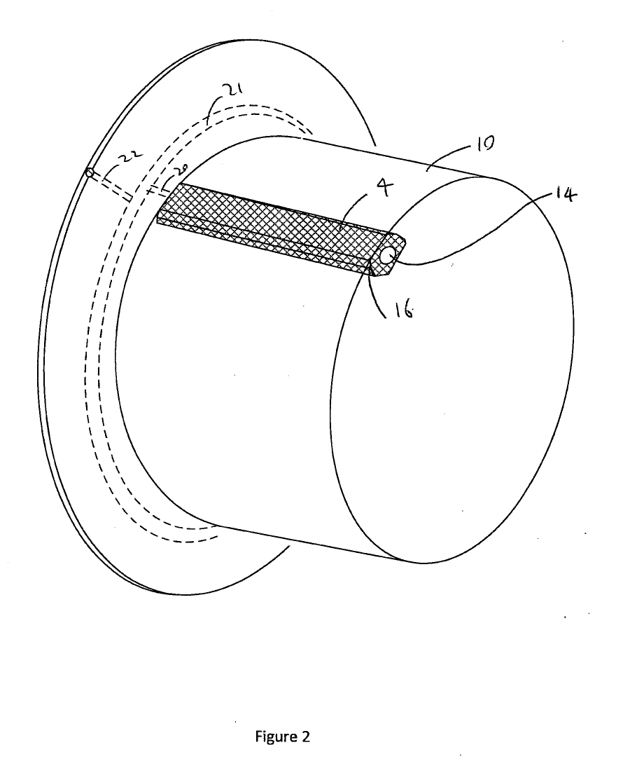

FIG. 2 shows a diagrammatic perspective view of an example of the barrier of FIG. 1 illustrating the location of a coupling element;

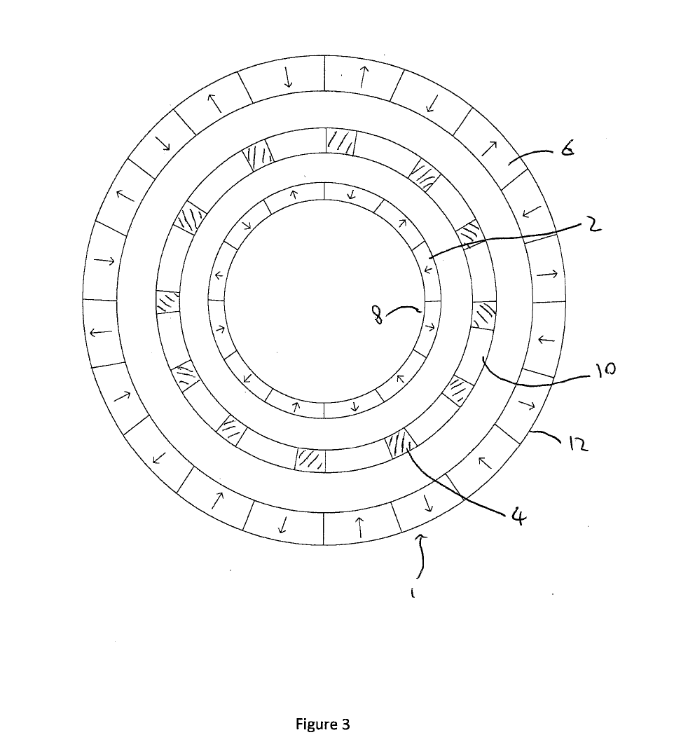

FIG. 3 shows a diagrammatic cross-sectional view of an example of the magnetic gear;

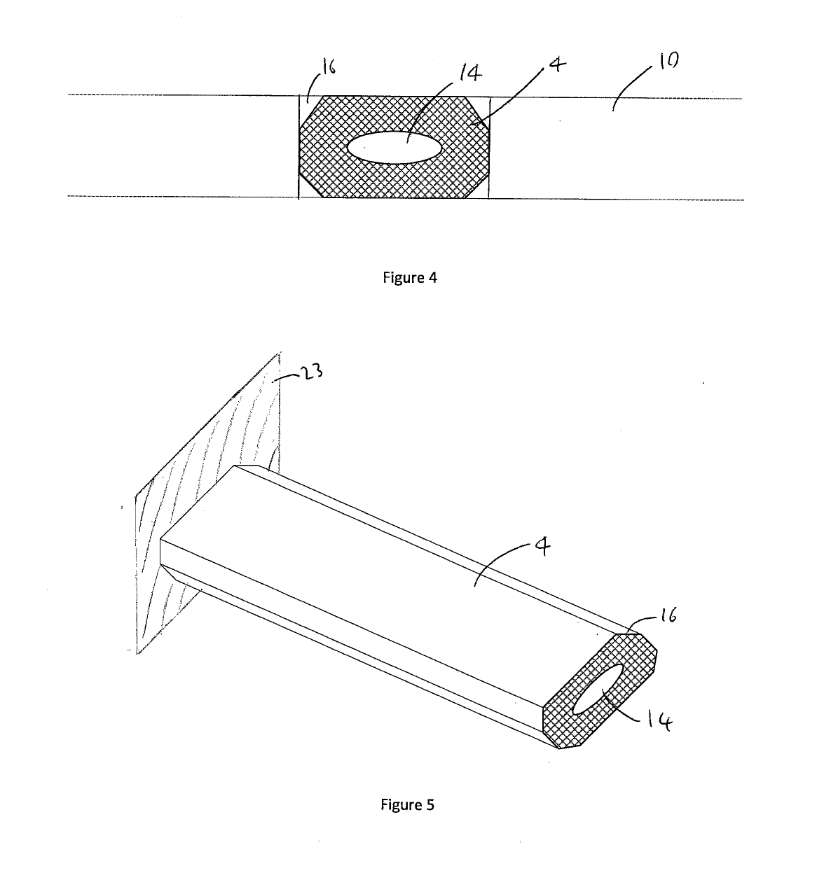

FIG. 4 shows a diagrammatic cross sectional view of a coupling element with bevelled corners; FIG. 5 shows a diagrammatic perspective view of the coupling element shown in FIG. 4;

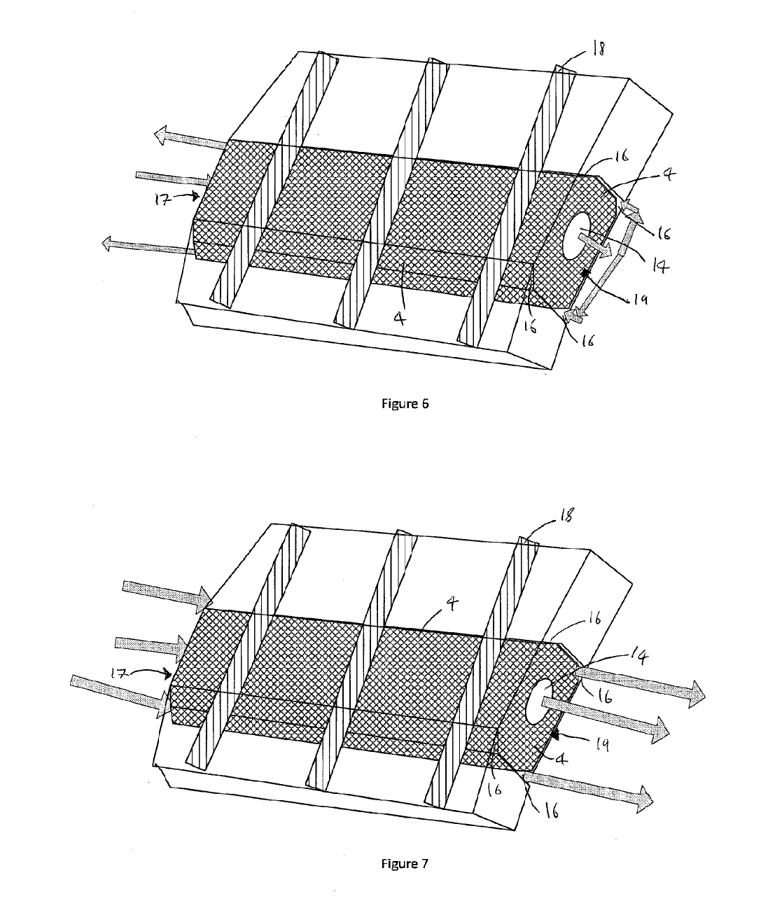

FIG. 6 shows a diagrammatic perspective view illustrating one example of a fluid flow associated with a coupling element;

FIG. 7 shows a diagrammatic perspective view illustrating another example of a fluid flow associated with a coupling element; and

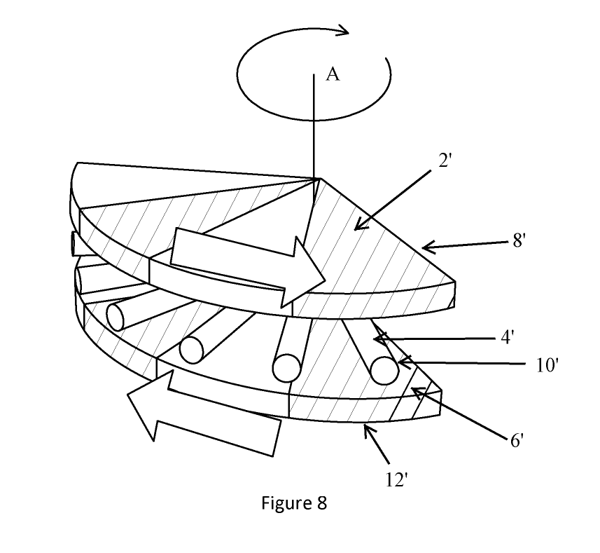

FIG. 8 shows a diagrammatic perspective view illustrating another example of a magnetic gear.

Referring now to the drawings in general, disclosed herein is a magnetic gear 1 having: first and second members 8 and 12 arranged for relative movement therebetween, the first member 8 having a first array of magnetic field generating elements 2 and the second member 12 having a second array of magnetic field generating elements 6; and a coupling member 10 having an array of coupling elements 4 for coupling magnetic flux between the first array of magnetic field generating elements 2 and the second array of magnetic field generating elements 6, wherein for at least one of the coupling elements 4, there is provided a fluid path 16 in thermal communication with the at least one coupling element, wherein the fluid path 16 is provided within at least one of the at least one coupling element 4 and the coupling member 10.

Referring now specifically to FIG. 1, there is shown a diagrammatic cross sectional view of a flywheel assembly 100 having such a magnetic gear 4. As shown in FIG. 1, the flywheel assembly has a flywheel chamber 110 containing a flywheel 101 with a rim 102 (having the majority of the mass) coupled via a web 103 to an axially extending flywheel shaft 104. The web may be spoked or continuous. The flywheel shaft 104 may be integrally formed with the web or may be a separate component. In the example shown the rim is a composite rim.

The shaft 104 is supported for rotation about its axis relative to the flywheel chamber 110 by means of bearings, for example bearings 105 shown in FIG. 1.

In the example shown in FIG. 1, the first array of magnetic field generating elements 2 provides an annular body 8a of the first member which is coupled via a web 8b (which may be spoked or continuous) to an axle 8c through which an end portion of the flywheel shaft 104 is coupled so that the flywheel is coupled for rotation with the first member 8.

In the example shown in FIG. 1, the coupling member 10 provides a barrier forming part of the flywheel chamber 110 which may in operation be under a low pressure or vacuum, that is may be a vacuum chamber, to reduce the windage (air resistance) on the flywheel.

FIG. 2 shows a perspective view of an example of a barrier where the barrier has a ‘top hat’ form. In the interests of clarity in FIG. 2 one elongate coupling element 4 is shown embedded within the barrier 10. It will be appreciated that in practice an array of elongate coupling elements will be positioned around the circumference of the barrier.

As shown in FIG. 1, the second array of magnetic field generating elements 6 provides an annular body 12a of the second member 12. The annular body 12a is coupled (as shown integral with) a drive shaft 106 which in use of the flywheel assembly may be coupled to a drive motor, for example a drive motor (not shown) of a vehicle.

An example of a magnetic gear suitable for use in the flywheel assembly described above will now be described in more detail with reference to FIGS. 2 to 5.

In the embodiment shown in FIG. 3 the first member 8, second member 12 and coupling member 10 are concentrically arranged annuli with the first member 8 providing an annular array of m magnetic field generating elements 2 and the second magnetic field generating elements 6 providing an annular array of n magnetic field generating elements 2, where the ratio m/n represents the gear ratio so that the rotational speed of the first member 8 is n/m times the rotational speed of the second member 12. The member with the greater number of magnetic poles therefore rotates at a slower angular velocity than the member with fewer magnetic poles. In the case of the flywheel assembly discussed above the higher speed rotor will be the first member 8 located in the flywheel chamber.

The magnetic field generating elements 2 and 6 may be, for example, rare earth magnets, any other appropriate form of permanent magnets or electromagnets. It will be appreciated that FIG. 3 is diagrammatic and that generally the coupling elements 4 will be equally sized and equally spaced around the circumference of the coupling member 10.

The coupling elements may be embedded within the coupling member or for example the coupling member may be keyed such that the coupling elements slot into the coupling member. FIGS. 6 and 7 show a coupling element 4 located within a coupling member 10 with a restraining band or bands 18 located on the coupling member to prevent movement of the coupling element during use. The restraining bands 18 may extend completely around the circumference of the coupling member. As another possibility, the restraining band or bands 18 may extend only partially around the circumference of the coupling member.

In this example, as shown in FIGS. 2 to 5, the fluid path is provided by an inner fluid channel 14 extending axially along the elongate coupling element. One end of the inner fluid channel 14 may be coupled to a fluid supply channel 20 provided in the ‘brim’ of the ‘top hat’ coupled via an annular manifold 21 to a fluid inlet 22 itself coupable to a fluid reservoir (not shown) provided outside of the barrier and in the example shown in FIG. 1 outside of the flywheel assembly. The fluid reservoir may be a pump or gravity fed arrangement. The other end of the inner fluid channel 14 may be coupled to a void in the ‘top hat’ from which it can drain into a sump (not shown).

In this example at least one longitudinal edge of the coupling element is bevelled to provide a “bevelled corner” defining with the barrier an outer fluid channel providing part of the fluid path 16. In the example shown all four longitudinal edges are bevelled to provide four outer fluid channels which has the advantage of more even cooling throughout the coupling element and reduction of edge effects therefore reducing heating due to concentration of the magnetic flux at the corner of the coupling element. In this case the fluid flow can be enter in through the inner fluid channel pass the length of the coupling element and out through the outer channels via a void inside the top hat. The outer channels may drain into a sump (not shown) or may couple back to the manifold forming a closed system. As another possibility the flow can be reversed.

The fluid reservoir or sump may be positioned within the bearing arrangement of the drive shaft in the case of the flywheel shown in FIG. 1, for example at 107 shown in FIG. 1.

As another possibility, as shown in FIG. 5, the inner fluid channel 14 may extend only partially through the coupling member 4 or may be sealed at one end and in either case the closed end of the inner fluid channel is coupled to a condensing plate so that the inner channel forms a heat pipe in which fluid is heated, evaporates and then re-condenses within the channel to effect cooling. In another embodiment the inner fluid channel contains a solid material that on heating evaporates of sublimes causing latent heat cooling upon change of state of the solid material. In either of these cases the channel may be completely sealed or open at the other end. Similarly or alternately the bevelled corner may be completely sealed or open at the other end providing a heat pipe as described above.

In the examples described above, a fluid path is provided in thermal communication with the at least one coupling element to provide a cooling path. As another possibility, a cooling path may be provided by a material of a lower magnetic permeability than the material of the coupling member extending at least partially through the at least one coupling element. In an example, the lower magnetic permeability may have a relative permeability of 1, i.e. the same relative permeability as air.

In an example the material of lower magnetic permeability may be thermally conductive, to enable heat to be conducted through the lower magnetic permeability forming a heat path.

Thus, in this example, the inner channel or inner channels 14 may comprise a material of a lower magnetic permeability than the material of the coupling member to provide a cooling path extending at least partially through the at least one coupling element. The magnetic flux in the coupling member will pass through the material of the coupling member, not through the material of lower magnetic permeability in the inner channel. The lower magnetic flux concentration in the material of the inner channel reduces the change of the flux in the material of the inner channel, therefore reducing the induced current and subsequent inductive heating. The material of lower permeability in the inner channel will be subjected to less inductive heating and therefore have a lower temperature relative to the material of the coupling member.

The material of lower magnetic permeability in the inner channel may be solid, liquid or gas. When a solid is used in the inner channel the solid may be, for example aluminium, copper or a composite material, as an example the composite material may be a carbon fibre composite. In this example, the coupling elements may be formed about the material of lower magnetic permeability or the material of lower magnetic permeability may be introduced into the channel in liquid form and then allowed to solidify, or may be provided as a separate rod or wire of solid material.

The solid material in the inner channel may provide an interference fit within the channel. In another example the solid material may have a smaller cross section than the inner channel. The material of lower magnetic permeability in the inner channel may be coupled to a heat sink away from the coupling member, allowing heat to flow from the material of the inner channel away from the coupling member and to dissipate via the heat sink. The inner channel may be a coated with a material different to the coupling member and the material of the inner channel, for example a coating may be applied to the surface of the inner channel using a material with a low magnetic permeability prevent magnetic flux penetrating into the inner channel.

Although the Figures show one inner cooling channel, the inner cooling channel may be a number of cooling channels passing through the coupling member. The channels may be arranged with a first inner channel forming a first cooling path and plurality of further inner channels forming cooling paths arranged around the first cooling path. The first cooling path may be arranged centrally within the coupling element and for example the further channels may be arranged symmetrically around the first channel. The cooling paths can be used as either a fluid supply path or a return path as discussed above. As another possibility, at least one inner cooling channel may provide a fluid supply path and at least one inner cooling channel may provide a return path.

Where there is more than one inner cooling channel, then one or more inner cooling channels may provide a fluid path and one or more inner cooling channels may contain material of lower magnetic permeability.

Only one, or two or more or all of the coupling elements may be provided with inner and outer cooling channels, or with only an inner cooling channel or channels or only an outer cooling channel or channels. As another possibility, at least one coupling element may have only an inner cooling channel or channels and no outer cooling channel or channels and at least one coupling element may have no inner cooling channel or channels and only an outer cooling channel or channels. The inner and/or outer cooling channels may be a mix of sealed and open channels, or all sealed channels or all open channels.

In some embodiments the coupling elements will have a mixture of coupling elements with at least one cooling channel and coupling elements without cooling channels.

As described above the fluid may be pumped or gravity fed. Where a pump 109 is provided, the pump may be coupled to a controller 110 configured to control the flow of fluid from the reservoir the fluid path, as show diagrammatically in FIG. 1. The controller may be configured to receive an indication of a measured temperature, for example from a temperature sensor thermally coupled to the coupling member, and to control the flow of fluid based on the comparison between the measured temperature and a reference temperature. The fluid pump may be, for example, an electric pump, a mechanical pump, or a hydraulically driven pump.

The fluid passes through a channel 14 and then passes back along a fluid path 16 adjacent to the coupling element. In the example shown in FIG. 5 a fluid is passed along a fluid supply path from a reservoir provided between the bearings on the input shaft to the fluid path 14, after passing through the coupling element the fluid is passes along cooling path 16 adjacent to the coupling element and is received by a return path returning the fluid to the reservoir.

The cooling path may be coupled to a tap and the controller configured to control the tap to control the pressure and/or mass flow of the fluid. Where the magnetic gear is associated with a hydraulic system, for example in the case of a vehicle, the hydraulic system may be used to provide the fluid, for example fluid may be bled under pressure from the hydraulic system.

FIGS. 6 and 7 show a perspective view of a coupling element 4 showing examples of fluid flow associated with a coupling element 4. The coupling elements in FIGS. 6 and 7 each comprise an inner cooling channel 14 and four cooling paths 16 adjacent to the coupling element. The arrows on FIGS. 6 and 7 provide a diagrammatic representation of the direction of flow of the fluid relative to the coupling element.

FIG. 6 shows an example where fluid from the fluid supply channel (FIG. 2) passes into a first end 17 of the inner cooling channel 14 of the elongate coupling element 4, along the length of the coupling element to a second end 19 of the inner cooling channel 14. At the second end 19 the fluid passes from the inner cooling channel 14, via a void (not shown) in the “top hat” coupling member, to one or more of the four cooling paths adjacent to the coupling element 4. The fluid then passes along the one or more of the four cooling paths back along the length of the coupling element 4 towards the first end 17 where the fluid may return to the reservoir or pass to a sump (neither shown in FIG. 6).

FIG. 7 shows an example where fluid passes along the length of the coupling element 4, from the first end 17 of the coupling element to a second end 19 of the coupling element, via the inner cooling channel 14 and the four cooling paths 16 adjacent to the coupling element 4. In this example fluid flows in the same direction in the inner cooling channel 14 and the four cooling paths 16.

In other examples than those shown in FIGS. 6 and 7, the fluid flow may not be in the same direction in each of the four cooling paths 16. For example, fluid may flow in one direction (for example in the direction from the end 17 to the end 19) in two of the cooling paths 16 and in the opposite direction in the other two of the cooling paths 16, or may flow in the same direction in three of the four cooling paths 16 and in the opposite direction in the other of the four cooling paths 16. In each case the fluid may flow in the inner cooling channel 14 from the first end 17 of the elongate coupling element 4 to the second end 19 of the elongate coupling element 4 or from the first end 17 of the elongate coupling element 4 to the second end 19 of the elongate coupling element 4.

As another possibility, a coupling element may have a porous or open cell structure with a plurality of channels each extending at least partially through the coupling element. The channels may be form capillary tubes in the coupling element. In this embodiment the capillary action of the channel may provide a force sufficient to move the fluid, in the liquid phase, relative to the coupling element. In an example the fluid may undergo a phase change, as described above, and the latent heat associated with that phase change may cool the coupling element.

As another possibility the material of lower magnetic permeability may have a cooling paths or a porous or open cell structure as described above.

Although as described above the reservoir, if present, is located between the bearings on the input shaft any such reservoir may be located at a different location on the flywheel assembly or elsewhere exterior to the flywheel assembly, for example another source within a structure, such as a vehicle, containing the flywheel assembly.

As another possibility, a local reservoir may not required, rather fluid may be supplied directly from an external fluid supply source.

After passing through and/or past the coupling element fluid may drain into a sump, pass into the flywheel assembly and evaporate or pass into the flywheel assembly and drain out of the flywheel assembly.

As another possibility, at least one cooling path may pass in a direction other than along the longitudinal axis of the elongate coupling member 4, for example in a direction transverse to the longitudinal axis. Also, one or more of the cooling paths need not necessarily be straight but could loop back upon itself to enter and exit the same end of the coupling element or may have a tortuous (non-linear) path between the ends 17 and 19. Any appropriate shape or configuration of cooling paths may be used to pass fluid within or along the coupling element.

As described above the magnetic gear has a concentric arrangement. As another possibility a linear arrangement may be used, with the relative movement between the first member 8 and second member 12 being linear rather than rotary.

As another possibility, as shown in FIG. 8, the first member 8′, coupling member 10′ and second member 12′ may be circular components stacked one on top of each other with a common axis A about which relative rotation is enabled. In this arrangement, the magnetic field generating elements 2′ and 6′ may be sectors of the respective circular components and the coupling elements 4′ may extend radially from the common axis, or a plurality of coupling elements may be distributed about the circumferences at a various radial distances from the axis.

In the examples described above the magnet gear has a gearing ratio where the number of magnetic field generating elements on the first member is not equal to the number of magnetic field generating elements on the second member. The magnetic gear ratio may, as another possibility, be 1:1 with the number of magnetic field generating elements on the first member being equal to the number of magnetic field generating elements on the second member.

In some examples, the coupling member 10 may be symmetrical about the axis of rotation of the first and/or second member. In other examples the coupling member 10 may be asymmetrical about the axis of rotation. The coupling member 10 may have a lug which is configured to engage with a corresponding recess in a housing of the magnetic gear (for example in a first housing portion 60 or a second housing portion 70) for securing the coupling member 10 in place relative to the housing.

While embodiments described above describe controlling the supply of fluid to the fluid path using a pump 109 controlled by a controller, additionally or alternatively a “passive” pump may be provided on the input shaft for pumping fluid to the fluid path in proportion to the rotational frequency of the input shaft. For example such a pump may be mounted on the input shaft, and may be arranged to be driven by the rotational energy of the input shaft to pump fluid from a reservoir or other fluid source to the fluid path in proportion to the rotational frequency of the input shaft. When a passive pump is used, it may be the case that a controller and sensors are not required.

As set out above, as another possibility, a linear gear may be provided, in which the first array of magnetic field generating elements 12 is provided in a first linear array, the second array of magnetic field generating elements 22 is provided in a second linear array, and the coupling elements are provided in a third array intermediate the first and second arrays. First and second moving magnetic fields may be provided by providing the first and second arrays of magnetic field generating elements by way of first and second arrays of permanent magnetic poles on first and second moveable members respectively, or one or both of the moving magnetic fields may be provided by an array of sequentially activated electromagnets. In a case where the first member is arranged to move, a linear coupling member may be coupled to the input rotor 14 via a rotational-to-linear converter or actuator, or the first member 10 may be driven by linear motion. The second linear member may be coupled to a flywheel or other rotational output via a linear-to-rotational converter or actuator or may be arranged to drive linear motion.

Embodiments of the invention may include any of the described features, described above in any combination.

1. A magnetic gear comprising:
first and second members arranged for relative movement therebetween, the first member having a first array of magnetic field generating elements and the second member having a second array of magnetic field generating elements; and
a coupling member having an array of coupling elements for coupling magnetic flux between the first array of magnetic field generating elements and the second array of magnetic field generating elements,
wherein for at least one of the coupling elements, there is provided a cooling path in thermal communication with the at least one coupling element, wherein the cooling path is provided within at least one of the at least one coupling element and the coupling member.

2. The magnetic gear of claim 1, wherein the cooling path is provided at least partially through the at least one coupling element.

3. (canceled)

4. The magnetic gear of claim 1, wherein the cooling path is provided adjacent to the coupling element.

5. (canceled)

6. The magnetic gear of claim 1, wherein a cross section of the at least one coupling element has at least one bevelled corner.

7. The magnetic gear of claim 6, wherein the at least one bevelled corner provides at least part of the at least one fluid path between the at least one coupling element and surfaces of the coupling member supporting the at least one coupling element.

8-13. (canceled)

14. The magnetic gear of claim 1, wherein the at least one coupling element is provided with two cooling paths, wherein the two cooling paths are provided within the coupling element.

15. (canceled)

16. The magnetic gear of claim 14, wherein the two cooling paths comprise fluid paths, wherein one of the two fluid paths is arranged to provide a fluid return path.

17. The magnetic gear of claim 1, wherein the at least one coupling element is provided with a plurality of cooling paths.

18-23. (canceled)

24. The magnetic gear of claim 1, wherein the or at least one cooling path comprises a fluid path, comprising a flow control element configured to control the flow of a fluid therealong.

25. (canceled)

26. The magnetic gear of claim 1, wherein the at least one cooling path comprises a fluid path, and the gear further comprises a controller configured to control the flow of fluid along the fluid path.

27-37. (canceled)

38. The magnetic gear of claim 1, wherein the one of the first and second members is coupled to an input shaft of the magnetic gear and the other of the first and second members is coupled to an output shaft of the magnetic gear.

39. (canceled)

40. The magnetic gear of claim 38, wherein the output shaft is arranged in a vacuum chamber.

41. The magnetic gear of claim 40, wherein the coupling member forms part of a barrier enclosing the vacuum chamber.

42-46. (canceled)

47. The magnetic gear of claim 1, wherein the at least one cooling path comprises a material of lower magnetic permeability in place of or in addition the at least one fluid path.

48-50. (canceled)

51. A magnetic gear comprising:
first and second members arranged for relative movement therebetween, the first member having a first array of magnetic field generating elements and the second member having a second array of magnetic field generating elements; and
a coupling member having an array of coupling elements for coupling magnetic flux between the first array of magnetic field generating elements and the second array of magnetic field generating elements,
wherein at least one of the coupling elements has a substantially rectangular cross section with at least one bevelled corner.

52. The magnetic gear of claim 51, wherein the bevelled corner provides a cooling path between the at least one coupling element and surfaces of the coupling member supporting the coupling element.

53. (canceled)

54. The magnetic gear of claim 1, wherein the coupling member has an outer circumferential surface configured to carry the coupling elements.

55-58. (canceled)

59. The magnetic gear of claim 1, wherein the coupling member has an inner circumferential surface, wherein inner surfaces of the respective coupling elements are flush with the inner circumferential surface.

60-61. (canceled)

62. A vehicle comprising the magnetic gear of claim 1.

63. A method of operating the magnetic gear of claim 1, the method comprising:
effecting relative movement between the first and second members; and
supplying fluid to the at least one fluid path to cool the at least one coupling element.
